(19) United States
(12) Patent Application Publication
(10) Pub. No.: US 2007/0050237 A1
(43) Pub. Date: Mar. 1, 2007

(54) Visual designer for multi-dimensional business logic

(75) Inventors: Ian Tien, Seattle, WA (US); Chen-I Lim, Bellevue, WA (US); Corey J. Hulen, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/214,678

(22) Filed: Aug. 30, 2005

(51) Int. Cl. H04M 3/51

(52) U.S. Cl. 705/11

(57) ABSTRACT

A user interface is provided for visual feedback to a user in a business logic application for generating summary scores from heterogeneous measures for monitoring organizational performance. The user interface includes presenting selections for a scoring pattern, a banding type, and an indicator scheme. In response to the selections, icons, labels, indicator ranges, trend diagrams, and band diagrams are generated. The graphic representations are modified dynamically in response to user adjustment of boundary values using sliders and numeric entries. Scorecards including Key Performance Indicators (KPI's) and rolled up KPI scores are created based on user interaction with the graphic user interface.

### BACKGROUND

Key Performance Indicators, also known as KPI or Key Success Indicators (KSI), help an organization define and measure progress toward organizational goals. Once an organization has analyzed its mission, identified all its stakeholders, and defined its goals, it needs a way to measure progress toward those goals. Key Performance Indicators are used to provide those measurements.

Key Performance Indicators are quantifiable measurements that reflect the critical success factors of an organization. Their use may differ depending on the organization. For example, a business may have as one of its Key Performance Indicators the percentage of its income that comes from return customers. A school may focus a KPI on the graduation rates of its students. A Customer Service Department may have as one of its Key Performance Indicators, in line with overall company KPIs, percentage of customer calls answered in the first minute. A Key Performance Indicator for a social service organization might be number of clients assisted during the year.

Moreover, measures employed as KPI within an organization may include a variety of types such as revenue in currency, growth or decrease of a measure in percentage, actual values of a measurable quantity, and the like. This may make comparing or combining different measures of performance a difficult task.

### SUMMARY

A user interface is provided for visual feedback to a user in an interactive business logic application. The user interface may include presenting selections of a scoring pattern, a banding type, and an indicator scheme for generating summary scores. In response to the selections, elements of the user interface including, but not limited to, icons, labels, indicator ranges, trend diagrams, and band diagrams may be generated.

The graphic representations may be modified dynamically in response to user adjustment of boundary values using sliders and numeric entries. Changes in slider positions and/or numeric entries for boundary values may be reflected in both formats. Sliders may be configured to enable the user to specify a target value beyond a best value in a score range. Sliders may also be configured to interactively change their positions, so that changes to the boundaries of the score range are reflected in the boundary values of individual bands within the score range.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a computing device in which an application according to an example embodiment may be executed;

FIG. 2 illustrates an example system, where example embodiments may be implemented;

FIG. 3 illustrates an example scorecard architecture according to aspects;

FIG. 4 illustrates a screenshot of an example scorecard;

FIG. 5 illustrates an example group of KPI bands;

FIG. 6 illustrates example visual representations of boundary value selections according to three different scoring patterns;

FIG. 7 illustrates boundary selection using text boxes and sliders, and relationship of boundary sliders with indicator ranges in boundary preview;

FIG. 8 illustrates a screenshot of a business logic application for selecting indicator ranges and editing banding settings;

FIG. 9A illustrates a screenshot of a banding settings editor for “Normalized Value of Actual/Target” type banding and “Increasing Is Better” type scoring pattern;

FIG. 9B illustrates a screenshot of a banding settings editor for “Normalized Value of Actual/Target” type banding and “Decreasing Is Better” type scoring pattern;

FIG. 9C illustrates a screenshot of a banding settings editor for “Normalized Value of Actual/Target” type banding and “Closer To Target Is Better” type scoring pattern;

FIG. 10A illustrates a screenshot of a banding settings editor for “Numeric Value of Actual” type banding and “Increasing Is Better” type scoring pattern;

FIG. 10B illustrates a screenshot of a banding settings editor for “Numeric Value of Actual” type banding and “Decreasing Is Better” type scoring pattern;

FIG. 10C illustrates a screenshot of a banding settings editor for “Numeric Value of Actual” type banding and “Closer To Target Is Better” type scoring pattern;

FIG. 11A illustrates a screenshot of a banding settings editor for “Stated Score” type banding and “Increasing Is Better” type scoring pattern;

FIG. 11B illustrates a screenshot of a banding settings editor for “Stated Score” type banding and “Decreasing Is Better” type scoring pattern;

FIG. 11C illustrates a screenshot of a banding settings editor for “Stated Score” type banding and “Closer To Target Is Better” type scoring pattern;

FIG. 12 illustrates a screenshot of a banding settings editor with boundary preview; and

FIG. 13 illustrates a logic flow diagram for a process of visually designing a scorecard computation.

### DETAILED DESCRIPTION

Embodiments of the present disclosure now will be described more fully hereinafter with reference to the accompanying drawings, which form a part hereof, and which show, by way of illustration, specific exemplary embodiments for practicing the invention. This disclosure may, however, be embodied in many different forms and should not be construed as limited to the embodiments set forth herein; rather, these embodiments are provided so that this disclosure will be thorough and complete, and will fully convey the scope to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

In organizations that seek to measure their business performance against quantitative targets there is a core design task of specifying how the assessment of actuals relative to targets is to take place. Traditionally, this has been done by consultants or developers implementing one-off, custom code for executive reporting systems.

Some business logic applications, such as Microsoft Office Business Scorecards Accelerator®, employ a parameter driven User Interface (UI) and specialized business logic for standardizing the definition of what was done previously in custom code.

Enabling business users to define the business logic on their own through a visual user interface may make the application not only more user-friendly, but also allow them to make the application available broadly across an organization.

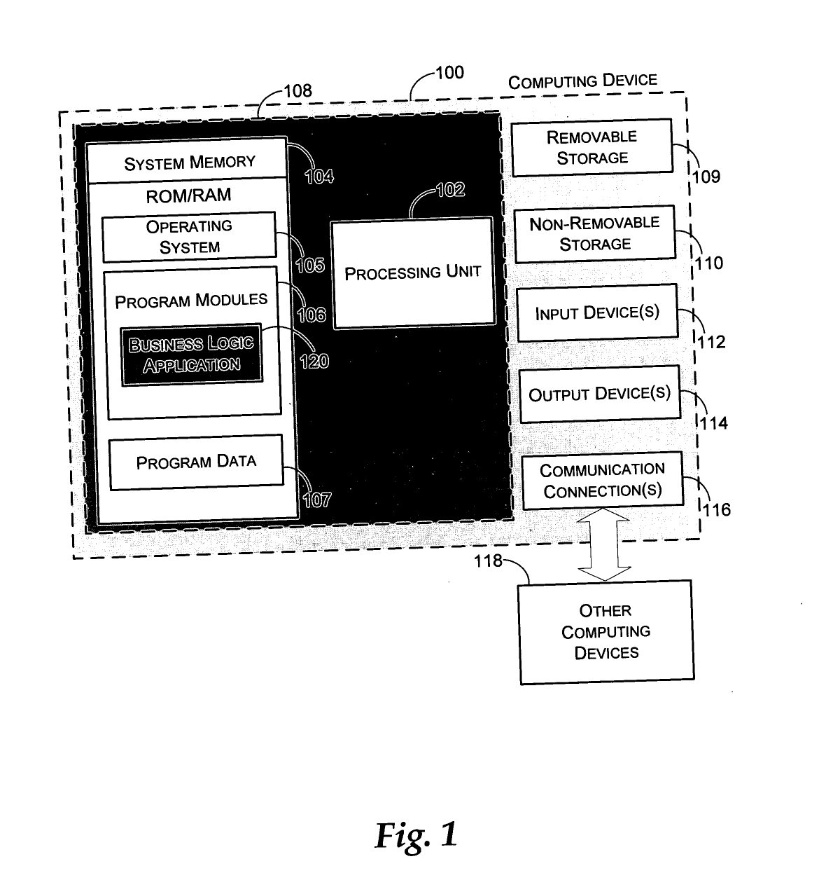

Illustrative Operating Environment Referring to FIG. 1, an exemplary system for implementing some embodiments includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes operating system 105, one or more program modules 106, and may include program data 107. This basic configuration is illustrated in FIG. 1 by those components within dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as retail devices, keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Communication connections 116 are one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

In one embodiment, program modules 106 further include business logic application 120. Business logic application 120 may include a scorecard application or any similar application to manage business evaluation methods. Business logic application 120 may use program data 107 and interact with other computing devices through communication connection(s) 116.

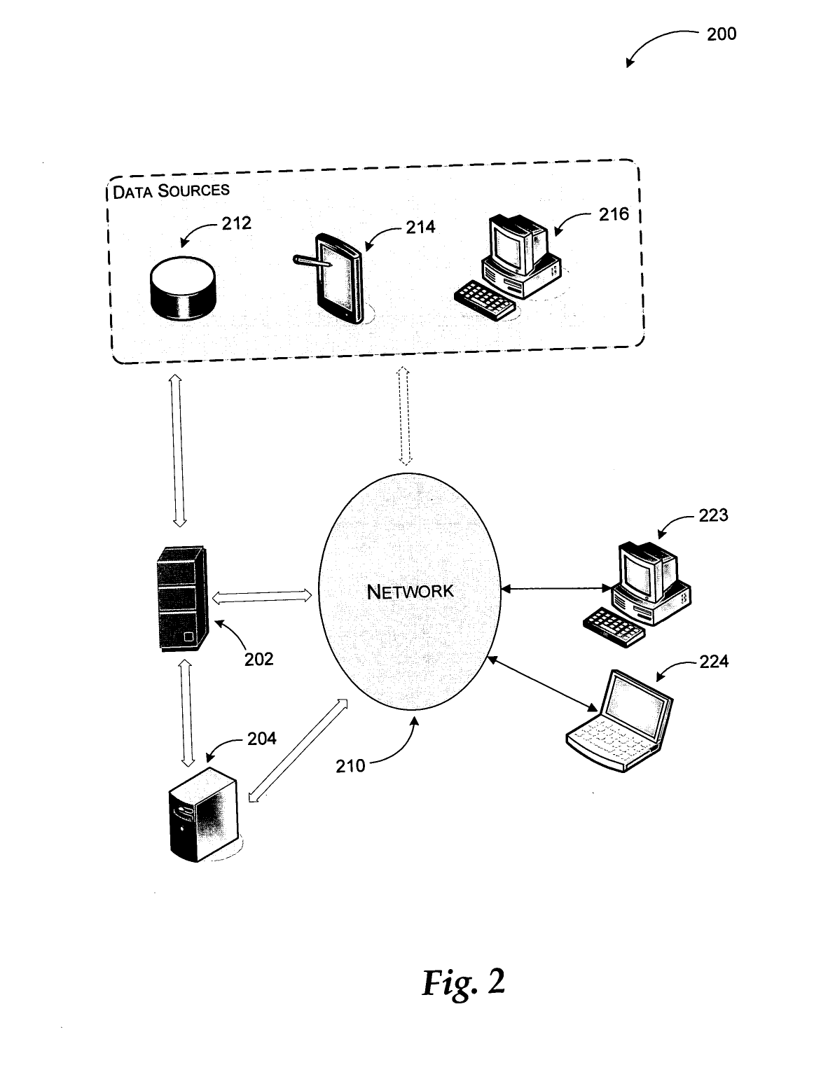

FIG. 2 illustrates example system 200, where example embodiments may be implemented. System 200 may comprise any topology of servers, clients, Internet service providers, and communication media. Also, system 200 may have a static or dynamic topology.

A business logic application may be run centrally on server 202 or in a distributed manner over several servers (e.g. servers 202 and 204) and/or client devices. Server 202 may include implementation of a number of information systems such as performance measures, business scorecards, and exception reporting. A number of organization-specific applications including, but not limited to, financial reporting/analysis, booking, marketing analysis, customer service, and manufacturing planning applications may also be configured, deployed, and shared in system 200.

Data sources 212, 214, and 216 are examples of a number of data sources that may provide input to server 202. Additional data sources may include SQL servers, databases, non multi-dimensional data sources such as text files or EXCEL® sheets, multi-dimensional data source such as data cubes, and the like.

Users may interact with server running the business logic application from client devices 223 and 224 over network 210. In another embodiment, users may directly access the data from server 202 and perform analysis on their own machines.

Network 210 may be a secure network such as an enterprise network, or an unsecure network such as a wireless open network. Network 210 provides communication between the nodes described above. By way of example, and not limitation, network 210 may include wired media such as a wired network or direct-wired connection, and wireless media such as acoustic, RF, infrared and other wireless media.

The present invention is not limited to the above described environment, however. Many other configurations of computing devices, applications, data sources, data distribution and analysis systems may be employed to implement a business logic application with visual user interface.

### Illustrative Embodiments For Visual Designer For Multi-Dimensional Business Logic

Embodiments are related to a user interface for enabling users to visually design business logic that scales from basic comparison to complex, multi-dimensional comparisons of actual and target quantities.

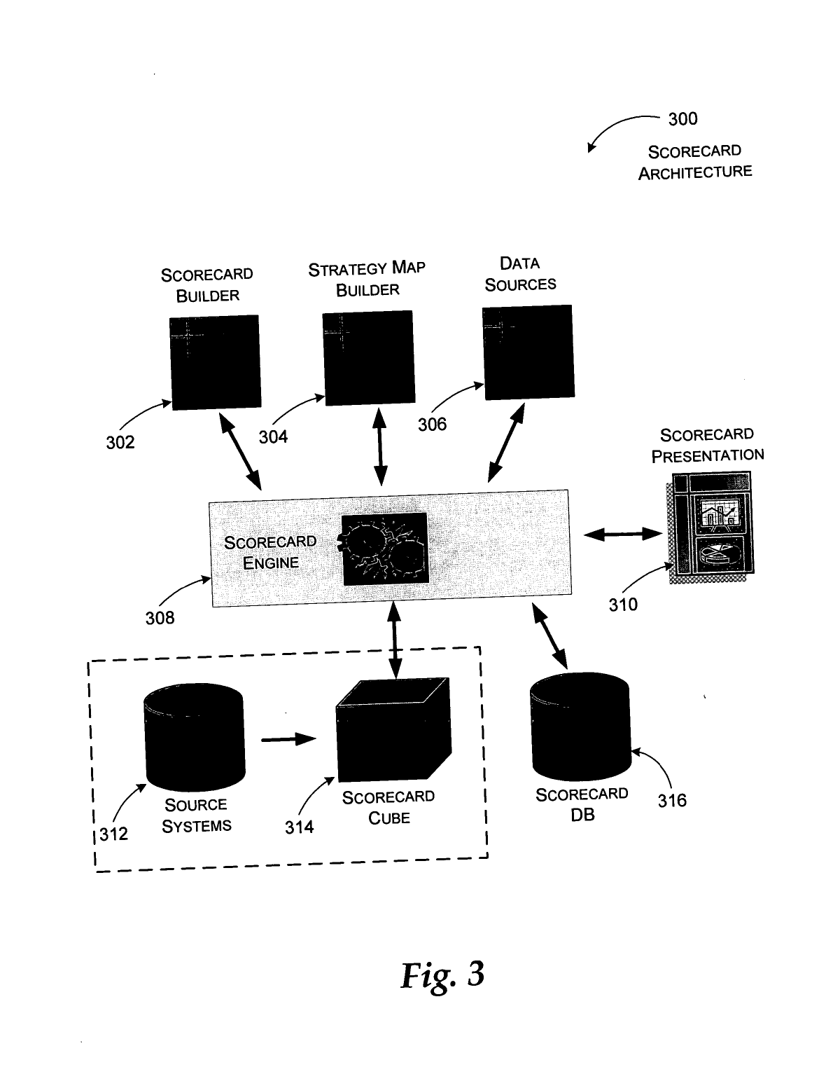

FIG. 3 illustrates example scorecard architecture 300. Scorecard architecture 300 may comprise any topology of processing systems, storage systems, source systems, and configuration systems. Scorecard architecture 300 may also have a static or dynamic topology.

Scorecards are an easy method of evaluating organizational performance. The performance measures may vary from financial data such as sales growth to service information such as customer complaints. In a non-business environment, student performances and teacher assessments may be another example of performance measures that can employ scorecards for evaluating organizational performance. In the exemplary scorecard architecture (300), a core of the system is scorecard engine 308. Scorecard engine 308 may be an application software that is arranged to evaluate performance metrics. Scorecard engine 308 may be loaded into a server, executed over a distributed network, executed in a client device, and the like.

Data for evaluating various measures may be provided by a data source. The data source may include source systems 312, which provide data to a scorecard cube 314. Source systems 312 may include multi-dimensional databases such OLAP, other databases, individual files, and the like, that provide raw data for generation of scorecards. Scorecard cube 314 is a multi-dimensional database for storing data to be used in determining Key Performance Indicators (KPIs) as well as generated scorecards themselves. As discussed above, the multi-dimensional nature of scorecard cube 314 enables storage, use, and presentation of data over multiple dimensions such as compound performance indicators for different geographic areas, organizational groups, or even for different time intervals. Scorecard cube 314 has a bi-directional interaction with scorecard engine 308 providing and receiving raw data as well as generated scorecards.

Scorecard database 316 is arranged to operate in a similar manner to scorecard cube 314. In one embodiment, scorecard database 316 may be an external database providing redundant back-up database service.

Scorecard builder 302 may be a separate application, a part of the performance evaluation application, and the like. Scorecard builder 302 is employed to configure various parameters of scorecard engine 308 such as scorecard elements, default values for actuals, targets, and the like. Scorecard builder 302 may include a user interface such as a web service, a GUI, and the like.

Strategy map builder 304 is employed for a later stage in scorecard generation process. As explained below, scores for KPIs and parent nodes such as Objective and Perspective may be presented to a user in form of a strategy map. Strategy map builder 304 may include a user interface for selecting graphical formats, indicator elements, and other graphical parameters of the presentation.

Data Sources 306 may be another source for providing raw data to scorecard engine 308. Data sources may be comprised of a mix of several multi-dimensional and relational databases or other ODBC-accessible data source systems (e.g. Excel, text files, etc.). Data sources 306 may also define KPI mappings and other associated data.

Finally, scorecard architecture 300 may include scorecard presentation 310. This may be an application to deploy scorecards, customize views, coordinate distribution of scorecard data, and process web-specific applications associated with the performance evaluation process. For example, scorecard presentation 310 may include a web-based printing system, an email distribution system, and the like.

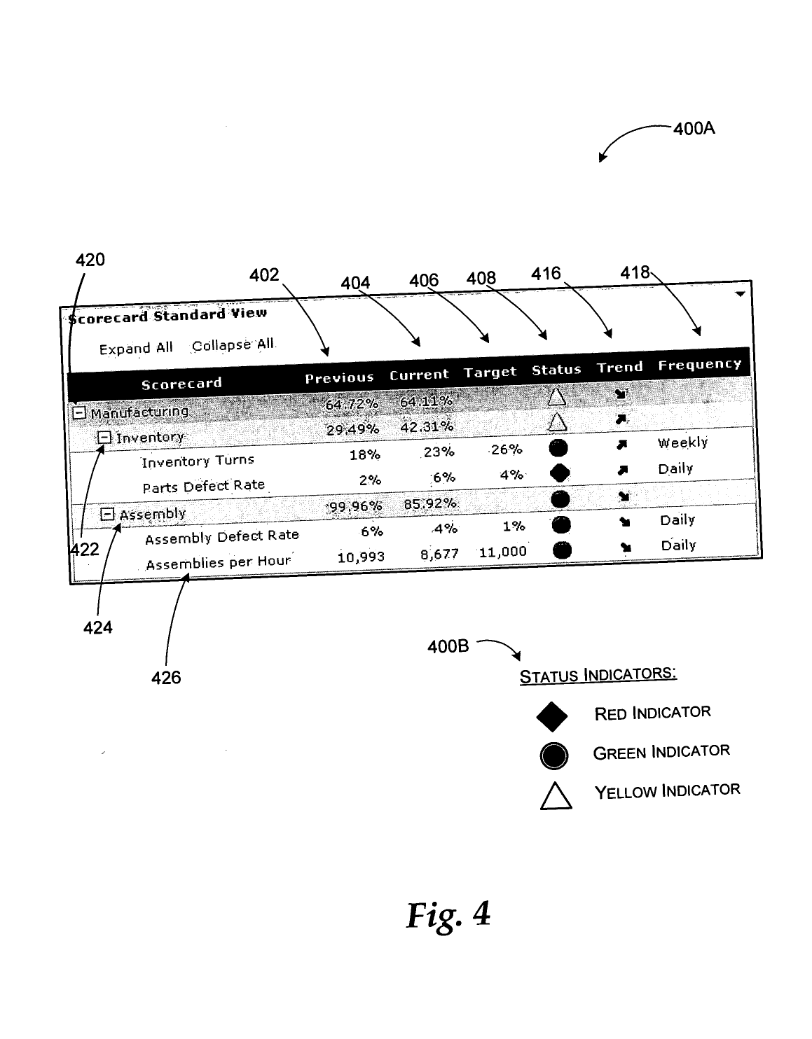

FIG. 4 illustrates a screenshot of example scorecard 400A with status indicators 400B.

As explained before, Key Performance Indicators (KPIs) are specific indicators of organizational performance that measure a current state in relation to meeting the targeted objectives. Decision makers may utilize these indicators to manage the organization more effectively.

When creating a KPI, the KPI definition may be used across several scorecards. This is useful when different scorecard managers might have a shared KPI in common. This may ensure a standard definition is used for that KPI. Despite the shared definition, each individual scorecard may utilize a different data source and data mappings for the actual KPI.

Each KPI may include a number of attributes. Some of these attributes include frequency of data, unit of measure, trend type, weight, and other attributes.

The frequency of data identifies how often the data is updated in the source database (cube). The frequency of data may include: Daily, Weekly, Monthly, Quarterly, and Annually.

The unit of measure provides an interpretation for the KPI. Some of the units of measure are: Integer, Decimal, Percent, Days, and Currency. These examples are not exhaustive, and other elements may be added without departing from the scope of the invention.

A trend type may be set according to whether an increasing trend is desirable or not. For example, increasing profit is a desirable trend, while increasing defect rates is not. The trend type may be used in determining the KPI status to display and in setting and interpreting the KPI banding boundary values. The arrows displayed in scorecard 400A of FIG. 4 indicate how the numbers are moving this period compared to last. If in this period the number is greater than last period, the trend is up regardless of the trend type. Possible trend types may include: Increasing Is Better, Decreasing Is Better, and On-Target Is Better.

Weight is a positive integer used to qualify the relative value of a KPI in relation to other KPIs. It is used to calculate the aggregated scorecard value. For example, if an Objective in a scorecard has two KPIs, the first KPI has a weight of 1, and the second has a weight of 3 the second KPI is essentially three times more important than the first, and this weighted relationship is part of the calculation when the KPIs' values are rolled up to derive the values of their parent Objective.

Other attributes may contain pointers to custom attributes that may be created for documentation purposes or used for various other aspects of the scorecard system such as creating different views in different graphical representations of the finished scorecard. Custom attributes may be created for any scorecard element and may be extended or customized by application developers or users for use in their own applications. They may be any of a number of types including text, numbers, percentages, dates, and hyperlinks.

One of the benefits of defining a scorecard is the ability to easily quantify and visualize performance in meeting organizational strategy. By providing a status at an overall scorecard level, and for each perspective, each objective or each KPI rollup, one may quickly identify where one might be off target. By utilizing the hierarchical scorecard definition along with KPI weightings, a status value is calculated at each level of the scorecard.

First column of scorecard 400A shows example elements perspective 420 “Manufacturing” with objectives 422 and 424 “Inventory” and “Assembly” (respectively) reporting to it. Second column 402 in scorecard 400A shows results for each measure from a previous measurement period. Third column 404 shows results for the same measures for the current measurement period. In one embodiment, the measurement period may include a month, a quarter, a tax year, a calendar year, and the like.

Fourth column 406 includes target values for specified KPIs on scorecard 400A. Target values may be retrieved from a database, entered by a user, and the like. Column 408 of scorecard 400A shows status indicators.

Status indicators convey the state of the KPI. An indicator may have a predetermined number of levels. A traffic light is one of the most commonly used indicators. It represents a KPI with three-levels of results—Good, Neutral, and Bad. Traffic light indicators may be colored red, yellow, or green. In addition, each colored indicator may have its own unique shape. A KPI may have one stoplight indicator visible at any given time. Indicators with more than three levels may appear as a bar divided into sections, or bands.

Column 416 includes trend type arrows as explained above under KPI attributes. Column 418 shows another KPI attribute, frequency.

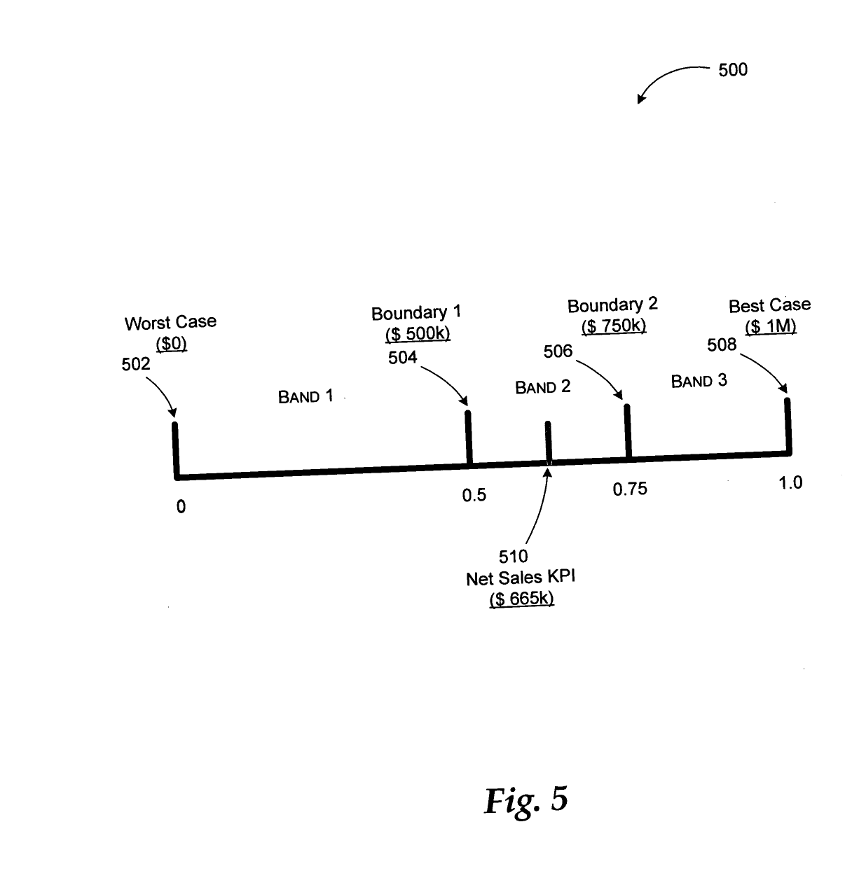

FIG. 5 illustrates example group of KPI bands 500.

Banding is a method used to set the boundaries for each increment in a scale (actual or evenly distributed) indicated by a stoplight or level indicator. KPI banding provides a mechanism to relate a KPI value to the state of the KPI indicator.

Once a KPI indicator is selected, the value type that is to be used to band the KPI may be specified, and the boundary values associated with the value type. KPI banding may be set while creating the KPI, although it may be more efficient to do so after all the KPIs exist.

The KPI value is reflected in its associated KPI indicator level. When creating a KPI, first a number of levels of the KPI indicator is defined. A default may be three, which may be graphically illustrated with a traffic light. Banding defines the boundaries between the levels. The segments between those boundaries are called bands. For each KPI there is a Worst Case boundary and a Best Case boundary, as well as (x-1) internal boundaries, where x is the number of bands. The worst and best case values are set to the lowest and highest values, respectively, based on expected values for the KPI.

The band values, i.e. the size of each segment may also be set by the user based upon a desired interpretation of the KPI indicator. The bands do not have to be equal in size.

In the example shown in FIG. 5, KPI bands 500 are for a Net Sales KPI, which has a Unit of Measure of currency. A stoplight scheme is selected, which contains three bands and the worst case (502) and the best case (508) are set to $0 and $1M, respectively. The boundaries are set such that a value up to $500k is in band 1, a value between $500k and $750k is in the band 2, and values above $750k are in band 3.

In the example, a KPI value of $665k (510) is placed two thirds of the way into the second band. The indicator may be colored. Its normalized value is 0.6667.

According to one embodiment, three banding types may be employed: Normalized Value of Actual/Target, Numeric Value of Actual, and Stated Score. A Band By selector may allow users to determine what value is used to determine the status of the KPI and also used for the KPI roll-up. The boundaries may reflect the scale of the Band By values.

Normalized values may be expressed as a percentage of the Target value in Normalized Value of Actual/Target type, which is generally the Best Case value. For example, a three-band indicator with four boundaries, may be defined by the following default values: Worst Case=0; boundary (1)=0.5; boundary (2)=0.75; Best Case=1. Normalized values may be applied for both KPI trend type Increasing Is Better and KPI trend type Decreasing Is Better.

Actual values are on the same scale as the values one expects to find in the KPI. If an organization has a KPI called “Net Sales,” with expected KPI and uses actual values from 0 to 30,000, the three-level indicator may be defined as follows: Worst Case=0; boundary (1)=15,000; boundary (2)=22,500; Best Case=30,000.

Stated score is a special case where the user wishes to band by number from −1 to 1, typically drawn from a cube measure, but may also be sourced from a user-entered value or ODBC data source.

For example, a user may be creating a scorecard, which compares the gross sales amounts for all of the sales districts. When the KPI “Gross Sales” is mapped in scorecard mapping, the “Gross Sales” number is determined that is displayed to the user. However, because the sales districts are vastly different in size, a sales district that has sales in the $100,000 range may have to be compared to another sales district that has sales in the $10,000,000 range. Because the absolute numbers are so different in scale, creating boundary values that encompass both of these scales may not provide practical analyses. So, while displaying the actual sales value, the application may normalize the sales numbers to the size of the district (i.e. calculate percentage of actual over target). Then, the boundary values may be set against the 1 to 100 normalized scale for determining the status of the KPI. Sales of $50,000 in the smaller district may be equivalent to sales of $5,000,000 in the larger district. A pre-normalized value may show that each of these sales figures is 50% of the expected sales range, thus the KPI indicator for both may be the same.

Other banding types such as Cube Measure and MDX score may also be implemented in other embodiments.

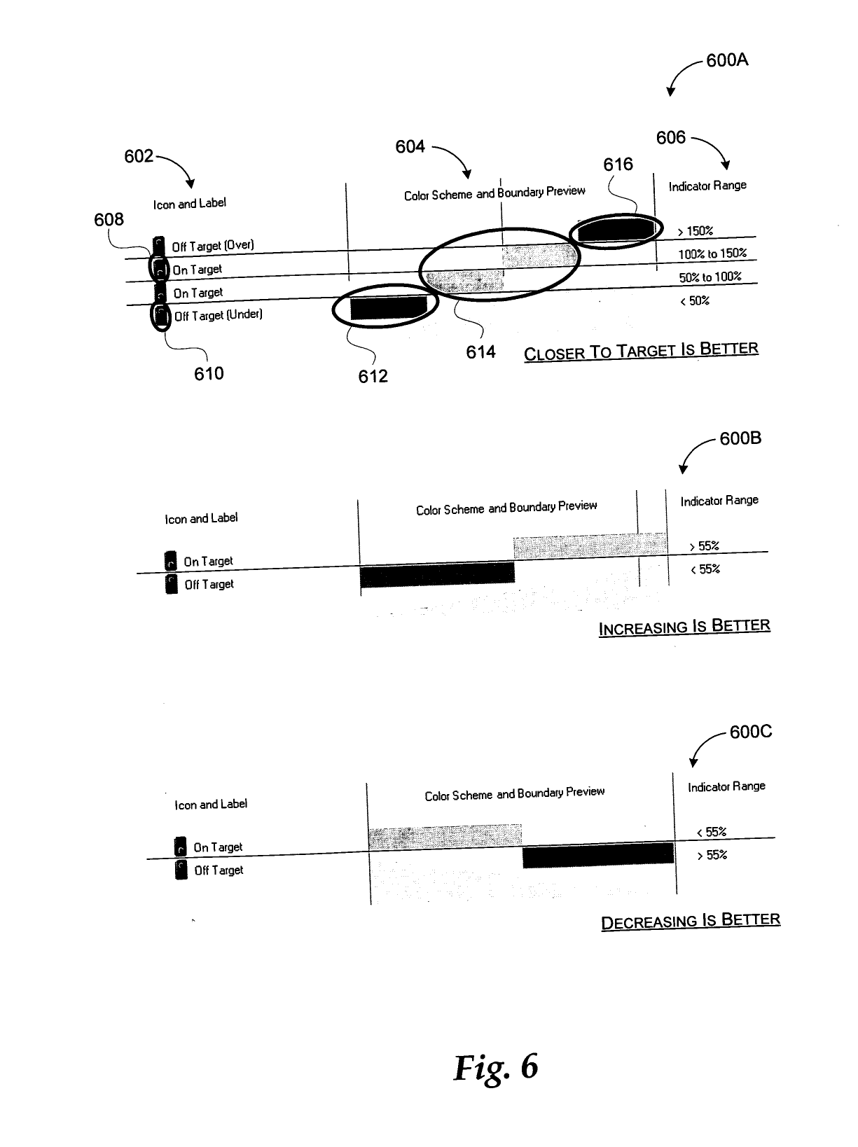

FIG. 6 illustrates example visual representations 600A-600C of boundary value selections according to three different scoring patterns.

Given the three types of scoring trends (Increasing Is Better, Decreasing Is Better, and Closer To Target Is Better) and the three ways to band (Band by Normalized Value of Actual/Target, Band by Numeric Value of Actual, and Band by Stated Score) the process of selecting the boundary values can become complex and confusing. Often, users desire a visual representation of their selections for boundary values for the selected indicator sets, as well as an easier way to select and manipulate these boundary values.

As visual representation 600A shows, the boundary value selections may be visualized as they relate to the indicator trend by showing an icon, a label, and a color scheme that is displayed when the score falls within a specific Indicator Range.

A variety of icons including, but not limited to, traffic light symbols, thermometer scales, sliding bars, smiley faces, and the like may be used to visualize the acceptability level of a score.

Similarly, colors of the bars indicate levels of acceptability such as green, yellow (612, 614), and red. Indicator Ranges 606 show percentage of actual over target as defined by the user-selected boundary values.

For example, if the score is 51%, the result is a green stoplight for the icon (icons 608 and 610), “On Target” for the label, and the corresponding bar is colored green (612). Other embodiments may include other coloring schemes for the bars and quantitations for the Indicator Range.

In one embodiment, the visual representation of the Icon, Label, Color Scheme, and Boundary Preview changes when the indicator trend is modified. Visual representation 600A shows the “Closer To Target Is Better” trend, visual representation 600B represents the “Increasing Is Better” trend, and visual representation illustrates the “Decreasing Is Better” trend.

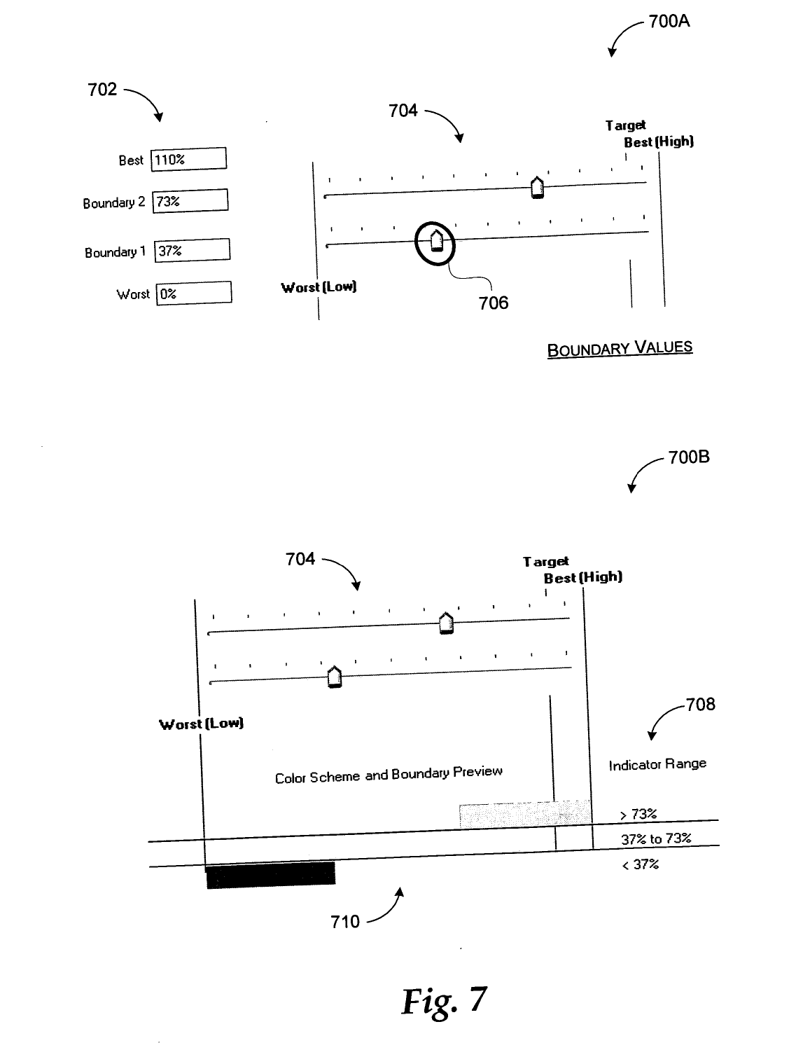

FIG. 7 illustrates boundary selection using text boxes and sliders, and relationship of boundary sliders with indicator ranges in boundary preview.

The user is provided with an option to use sliders to manipulate the boundary values or to manually enter them. In some embodiments, there may be more than one lower and upper boundary values (e.g. Closer To Target Is Better). The controls for entering Boundary Values are shown in user interface 700A. When a user drags the slider (e.g. slider 706) in slider region 704 of the user interface, the values in the text boxes of text box region 702 are changed to reflect the current position of the slider. Conversely, when a boundary is manually entered into the text box the sliders are automatically adjusted to the correct position to reflect the change.

The number of sliders displayed is equal to the number of boundaries for the selected Indicator. In the case when there is more than one boundary value, the sliders restrict the user from overlapping boundaries. For example, if Boundary 1's slider is dragged to the right past Boundary 2's slider, Boundary 2's slider is automatically updated to be at the same position as Boundary 1's slider. This update is also reflected in the Boundary 2's text box. Following the same behavior of restricting overlapping with the sliders, if a boundary value is entered past another in the text box, the overlapped boundary value is changed.

The sliders and text boxes are not the only objects whose behavior is linked together. When the slider is moved, the changes are also reflected in the Boundary Preview and the Indicator Range regions as shown in user interface 700B. The boundaries may be depicted by a change in color and level in Boundary Preview chart 710. As shown in user interface 700B, the boundaries are depicted directly below slider region 702.

When a user drags a slider, the corresponding boundary is moved to reflect the change in slider position. The values under Indicator Range 708 are also updated to reflect the boundary changes and depict the correct values for the range. For example, in user interface 700B the lighter colored bar (indicating acceptable but potentially problem status) grows and the darker colored bar (indicating acceptable status) gets shorter, if the upper boundary is moved to the right to 80%. The 73% value in the Indicator Ranges is also changed to 80%.

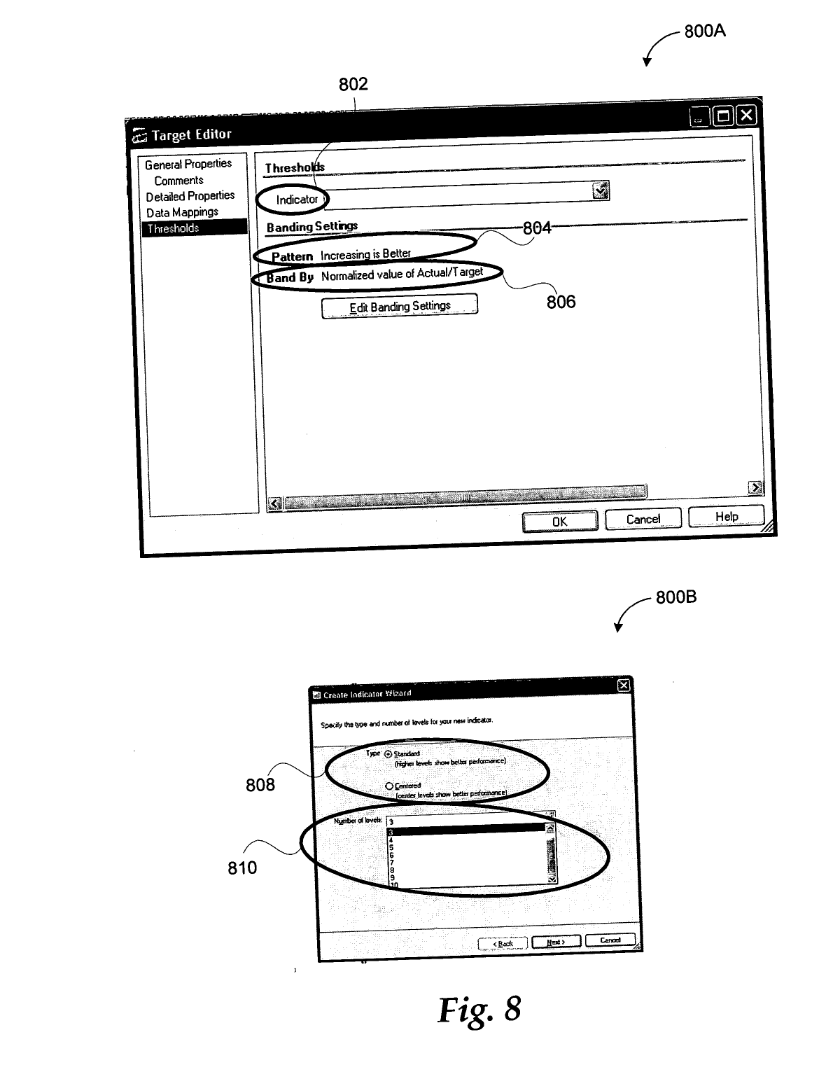

FIG. 8 illustrates screenshots 800A and 800B of a business logic application user interface for selecting indicator ranges and editing banding settings.

Screenshot 800A directs the user to select an indicator scheme (802) and shows the already selected scoring pattern “Increasing Is Better” 804 and banding type “Normalized Value of Actual/Target” 806.

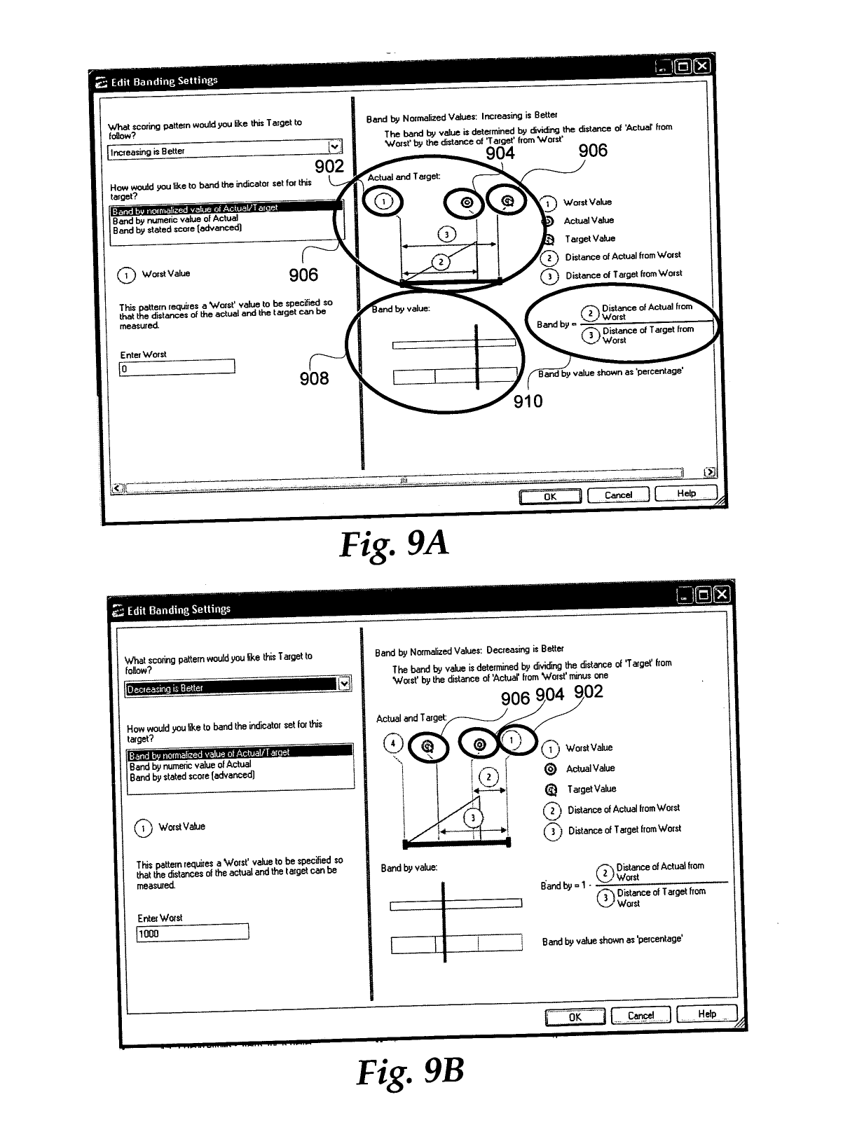

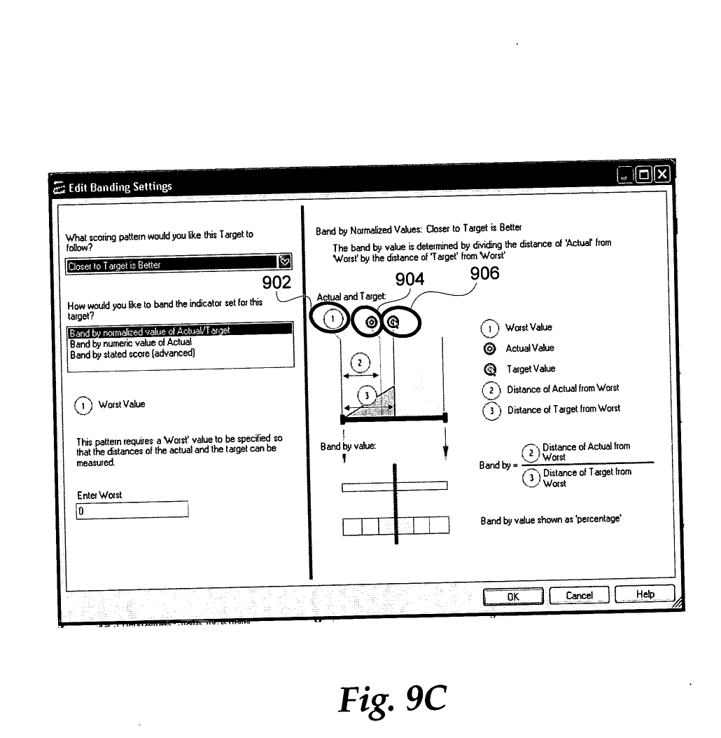

The user interface also allows the user to select an “Edit Banding Settings” option resulting in various editor screens as shown in FIGS. 9A-11C below.

Screenshot 800B shows an indicator selection wizard. In one embodiment, the indicator schemes may be selected from a drop-down menu as shown in screenshot 800A or using a wizard as shown in screenshot 800B.

In the indicator wizard, the user is first prompted to select between a standard type indicator and a centered type indicator (810). In the standard type indicator, higher levels show better performance. In the centered type indicator, center levels show better performance. Other embodiments may include further performance indicators.

Next, the user is prompted to select a number of levels in section 812 of screenshot 800B. The number of levels is reflected in the number of bands, indicator ranges, and associated icons and labels of the generated scorecard views later on.

FIG. 9A illustrates a screenshot of a banding settings editor for “Normalized Value of Actual/Target” type banding and “Increasing Is Better” type scoring pattern.

In this banding settings editor screen, a user is prompted to select (or modify an existing selection) a scoring pattern and a banding type. The example band setting for “Normalized Value of Actual/Target” type banding and “Increasing Is Better” type scoring pattern requires a worst value to be specified by the user. The band value is then determined by dividing the distance between the Actual value and the worst value to the distance between the Target value and the worst value.

On the user interface screen, worst value 902, actual value 904 and target value 906 are shown along with a bar diagram (908). A calculation of Band By value (910) is illustrated for the user. Bar diagram 908 also includes a description and picture of the Indicator Trend when using a specific Banding Pattern.

FIG. 9B illustrates a screenshot of a banding settings editor for “Normalized Value of Actual/Target” type banding and “Decreasing Is Better” type scoring pattern.

Elements of the user interface screen are the same as in FIG. 9A. Similar to the previous band settings, the user is prompted to enter a worst value. Due to the selection of scoring pattern “Decreasing Is Better”, worst value 902 is placed as the left boundary of the Indicator Trend diagram. The calculation of the distances for Actual and Target values for Band By values are also determined from the left boundary.

FIG. 9C illustrates a screenshot of a banding settings editor for “Normalized Value of Actual/Target” type banding and “Closer To Target Is Better” type scoring pattern.

Elements of the user interface screen are the same as in FIGS. 9A and 9B. The user is again prompted to enter a worst value. The Band By value is still determined by dividing the distance between Actual value 904 and worst value 902 to the distance between Target value 906 and worst value 902.

The selection of scoring pattern “Closer To Target Is Better” results in determination of acceptability (score) based on how close an actual value is to the target value. The Indicator Trend diagram and the percentage placement of the actual within the band are also illustrated.

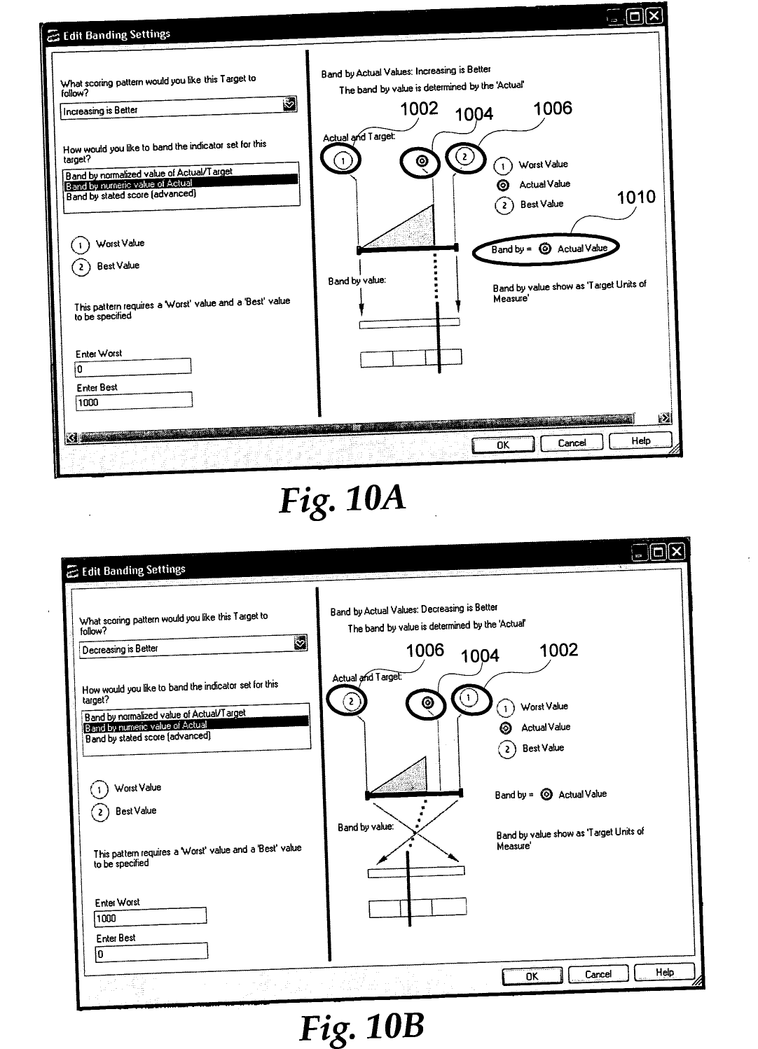

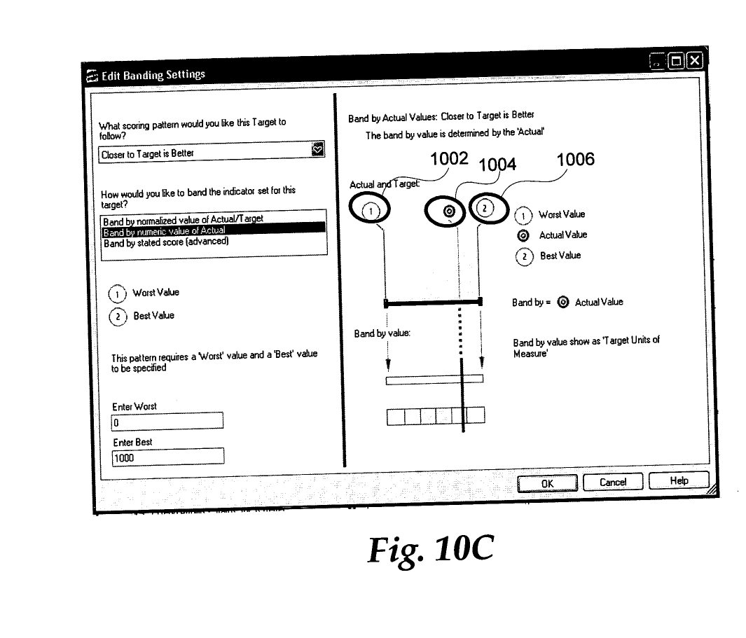

FIG. 10A illustrates a screenshot of a banding settings editor for “Numeric Value of Actual” type banding and “Increasing Is Better” type scoring pattern.

The user is prompted to enter a best value (1002) and a worst value (1006) for “Numeric Value of Actual” type banding and “Increasing Is Better” type scoring pattern. Best value 1002 and worst value 1006 are used to determined boundaries of the band. Actual value 1004 is also indicated on the Indicator Trend diagram as well as the linear scale percentage diagram.

The Band By value (1010) is determined by the actual value and shown as target units of measure.

FIG. 10B illustrates a screenshot of a banding settings editor for “Numeric Value of Actual” type banding and “Decreasing Is Better” type scoring pattern.

Elements of the user interface screen are the same as in FIG. 10A. The user is again prompted to enter best value 1006 and worst value 1002. The boundaries of the Indicator Trend and the percentage placement diagrams are reversed due to the “Decreasing Is Better” scoring pattern.

FIG. 10C illustrates a screenshot of a banding settings editor for “Numeric Value of Actual” type banding and “Closer To Target Is Better” type scoring pattern.

Elements of the user interface screen are the same as in FIGS. 10A and 10B. The user is still prompted to enter best value 1006 and worst value 1002. The Band By value determined by the actual value is shown as target units of measure.

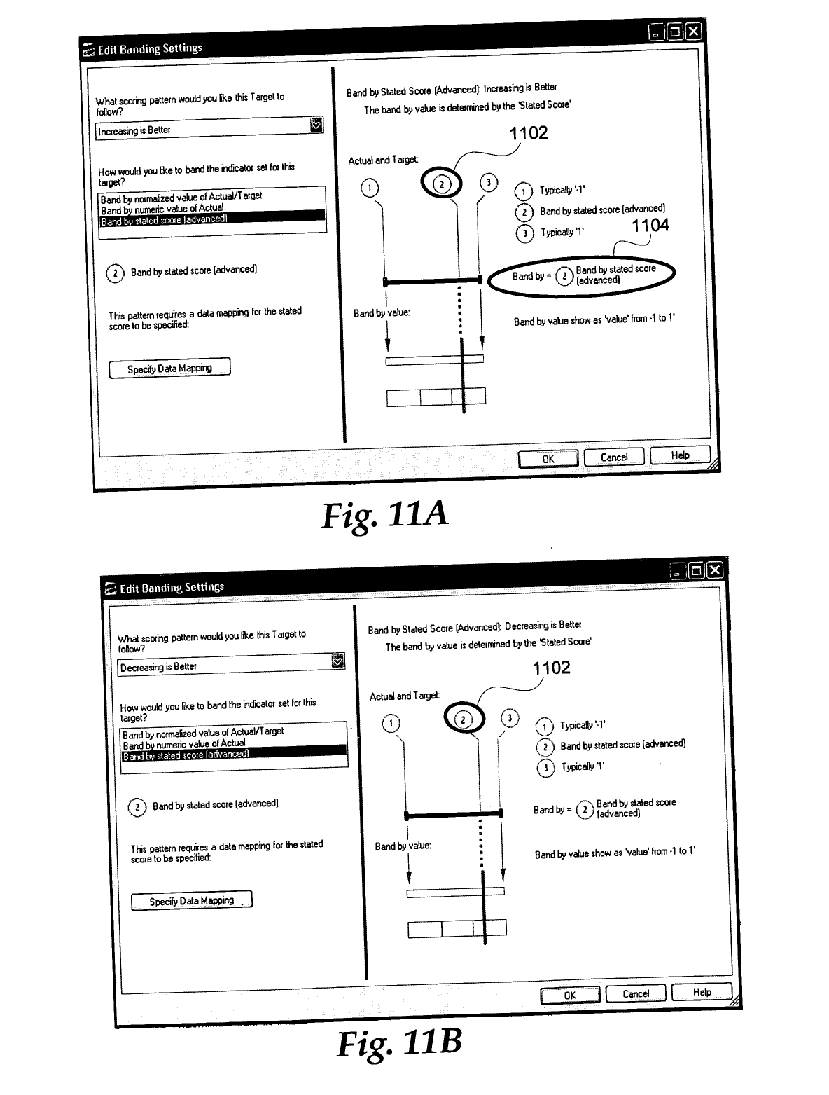

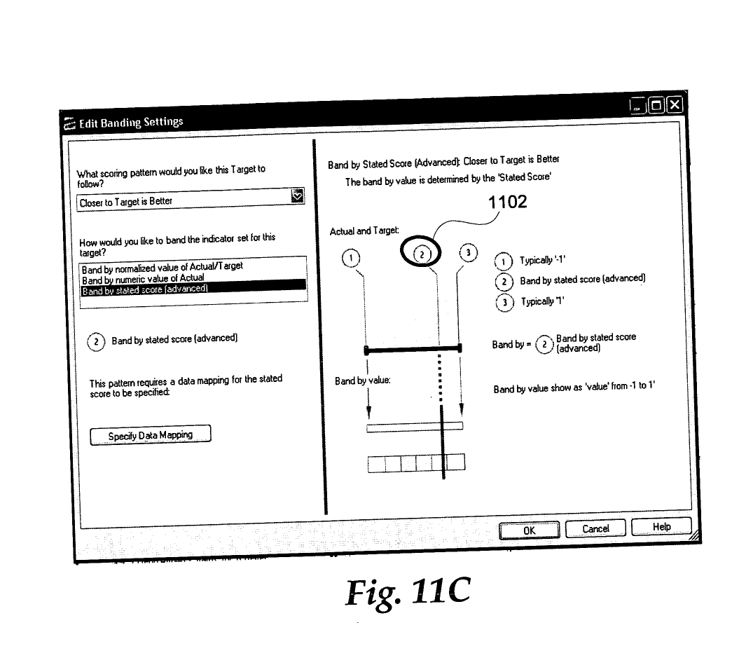

FIG. 11A illustrates a screenshot of a banding settings editor for “Stated Score” type banding and “Increasing Is Better” type scoring pattern.

The user is prompted to specify a data mapping for the stated score in case of “Stated Score” type banding and “Increasing Is Better” type scoring pattern. For the Stated Score, the user specifies a Band By number from −1 to 1, typically drawn from a cube measure, but may also be sourced from a user-entered value or ODBC data source.

Accordingly, the boundaries for the Indicator Trend diagram as well as the linear scale percentage diagram are determined by the user defined values for the band. The stated score (1102) is indicated on both diagrams.

FIG. 11B illustrates a screenshot of a banding settings editor for “Stated Score” type banding and “Decreasing Is Better” type scoring pattern.

Elements of the user interface screen are the same as in FIG. 11A. The user is still prompted to specify the stated score defining the boundaries of the band as −1 and 1 (typically). Other boundaries may also be defined in other embodiments.

FIG. 11C illustrates a screenshot of a banding settings editor for “Stated Score” type banding and “Closer To Target Is Better” type scoring pattern.

Elements of the user interface screen are the same as in FIGS. 11A and 11B. The boundaries of the band are determined based on the user specified stated score. The score is determined by “Closer to Target” criterion.

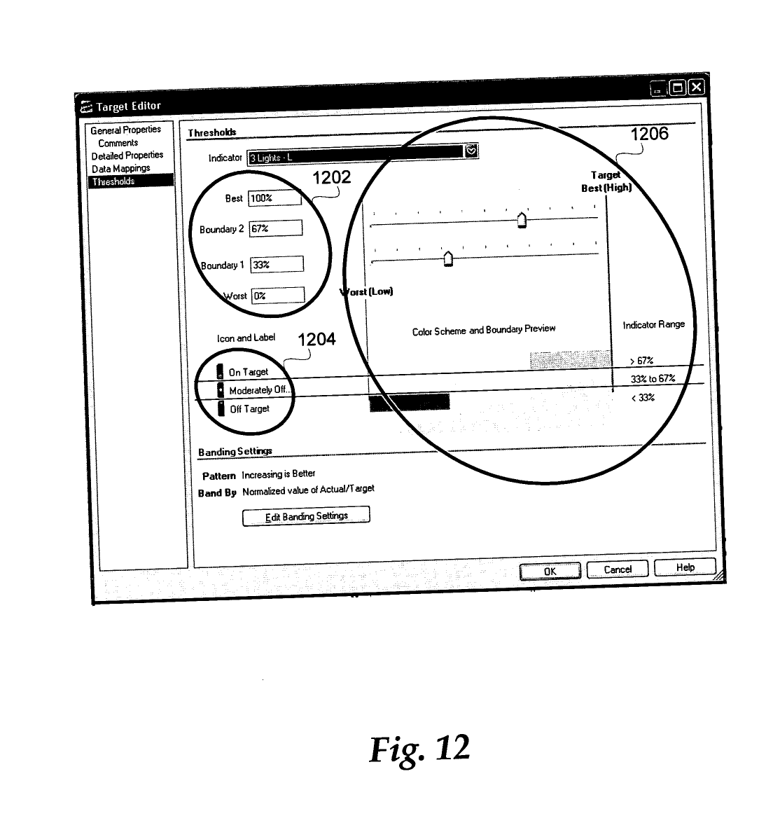

FIG. 12 illustrates a screenshot of a banding settings editor with boundary preview.

The screenshot shows the user interface after a user has selected the indicator scheme, scoring pattern, and banding type. The editor screen of the user interface includes sliders, Boundary Preview, and Indicator Range in section 1206. This section provides the user with a graphical representation of the score range, a coloring scheme that visualizes an acceptability level of different bands.

Section 1202 of the editor screen includes text boxes that reflect numeric values of the boundary values, as well as best and worst case values. Finally, section 1204 of the editor screen includes icons and labels corresponding to the different bands.

The user can modify numeric values of the boundaries (band boundaries or range boundaries) by entering new numeric values in the text boxes or by adjusting a position of the sliders corresponding to the boundary values. In either case, both representations are updated to reflect the change along with the Boundary Preview and Indicator Range.

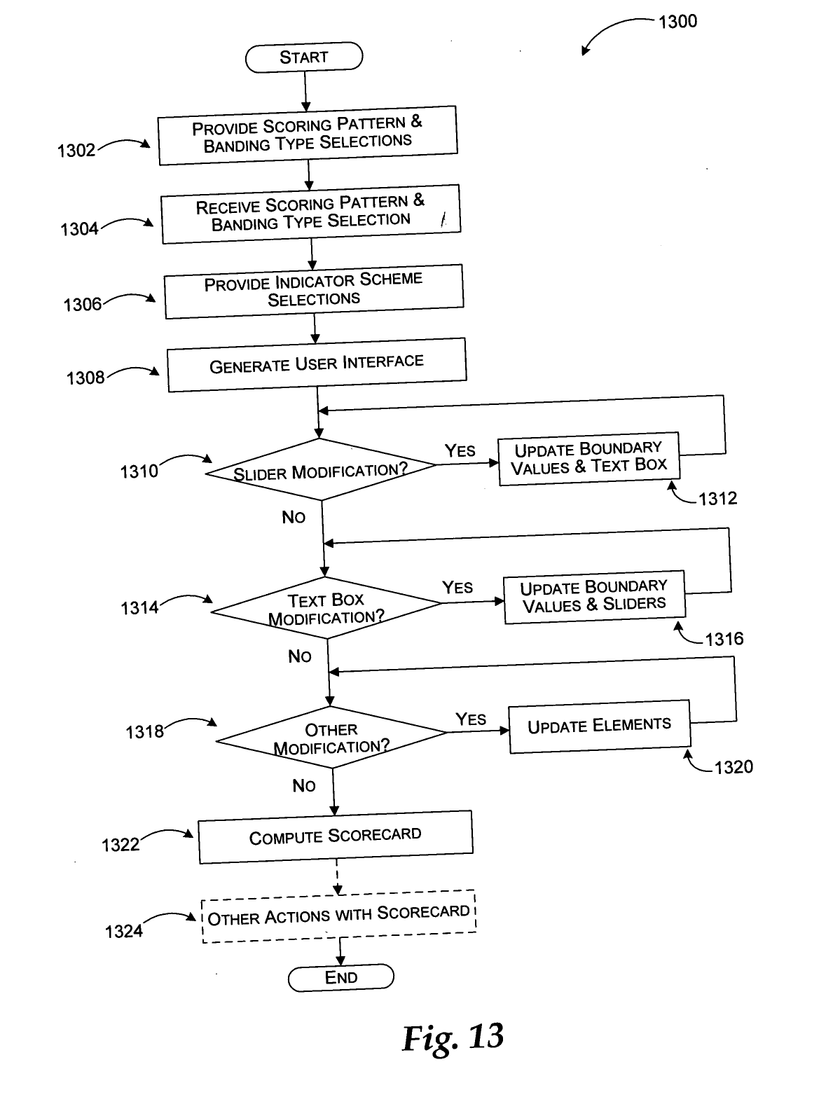

FIG. 13 illustrates a logic flow diagram for process 1300 of visually designing a scorecard computation.

Process 1300 begins at operation 1302, where available scoring pattern and banding type selections are provided to a user. In one embodiment, the available scoring pattern selections include “Increasing Is Better”, “Decreasing Is Better”, and “Closer To Target Is Better”. The available banding types may include “Normalized Value of Actual/Target”, “Numeric Value of Actual”, and “Stated Score.” These scoring pattern and banding types have been described previously. Processing advances from operation 1302 to operation 1304.

At operation 1304, the user's selections of the scoring pattern and banding type are received. Following operation 1304, processing moves to operation 1306, where a selection of indicator schemes is provided to the user. As mentioned before, indicator schemes may include, but are not limited to, icons, labels, percentage diagrams, and band coloring schemes. Upon receiving the user's selection of the indicator scheme, processing advances to operation 1308.

At operation 1308, a user interface is generated that includes various elements of the indicator scheme such as those described above as well as an indicator trend diagram, a range indicator, and the like. The user interface may include various presentations. For example, one presentation of the user interface may be an editor that enables the user to make modifications to elements of the scorecard input data such as band boundary values, target value, best and worst values, and the like.

In one embodiment, the editor within the user interface may include a number of sliders to set or modify the boundary values, and a number of text boxes to modify the same by entering numeric values. Processing proceeds from operation 1308 to decision operation 1310.

At decision operation 1310, a determination is made whether a modification is made using the sliders. If the decision is negative, processing moves to decision operation 1314. Otherwise, processing advances to operation 1312.

At operation 1312, the boundary values are updated according to the changes made with the sliders. At the same time the numeric values corresponding to the boundary values reflected in the text boxes are also updated. In one embodiment, the sliders may be configured such that adjustment of one slider interactively affects other sliders. For example, moving a slider corresponding to a range boundary may set the limits and move other sliders corresponding to the band boundaries within the range.

Processing returns to decision operation 1310 from operation 1312 for a determination whether further changes are made using the sliders.

At decisions operation 1314, a determination is made whether a modification is made by entering a numeric value in one or more of the text boxes. If the decision is negative, processing moves to decision operation 1318. Otherwise, processing advances to operation 1316.

At operation 1316, the boundary values are updated according to the changes made in the text boxes. At the same time the positions of the sliders corresponding to the boundary values reflected in the text boxes are also updated. Processing returns to decision operation 1314 from operation 1316 for a determination whether further changes are made in the text boxes.

At decisions operation 1318, a determination is made whether any other modifications are made in the editor screen of the user interface. For example, a user may change the scoring pattern, or the banding type. If the decision is negative, processing moves to operation 1322. Otherwise, processing advances to operation 1320.

At operation 1320, user interface elements are updated according to the changes made. Processing returns to decision operation 1318 from operation 1320 for a determination whether further changes are made.

At operation 1322, changes are completed and the scorecard is computed.

In some embodiments, the scorecards may include rolled-up calculations of weighted KPI's such as Objectives, Perspectives, KPI groups, and the like.

From operation 1322, processing may move to optional operation 1324, where other actions associated with the scorecard are facilitated. Such actions may include, providing visual presentations, communicating alerts etc. to predetermined participants, and the like.

After optional operation 1324, processing moves to a calling process for further actions.

The operations included in process 1300 are for illustration purposes. Providing a user interface for dynamic generation and modification of scorecard elements may be implemented by a similar process with fewer or additional steps including interacting with other applications, using default parameters, using additional graphic representations, and the like.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computer-implemented method for providing a user interface for generating summary scores from heterogeneous measures stored in a hierarchical structure, comprising:
providing a scoring pattern selection and a banding type selection;
providing an indicator scheme selection based on a selected scoring pattern and a selected banding type, wherein the indicator scheme includes at least a number of bands within a score range;
providing the user interface based on the selected scoring pattern, the banding type, and the indicator scheme such that boundary values are determined for the bands; and
dynamically adjusting the user interface to reflect a scale between at least one lower boundary value and an at least one upper boundary value for the measure that includes the selected number of bands and a placement of a target value and an actual value within the scale.

2. The computer-implemented method of claim 1, wherein the boundary values for the bands are determined based on one of a numeric entry in a text box and a manipulation of a slider.

3. The computer-implemented method of claim 2, wherein elements of the user interface are further adjusted in response to one of the numeric entry in the text box and the manipulation of a slider.

4. The computer-implemented method of claim 2, wherein the user interface is arranged to modify the numeric value in the text box in response to a change of a boundary value by manipulation of the slider, and to adjust a position of the slider in response to a change of the boundary value by an entry of the numeric value in the text box.

5. The computer-implemented method of claim 2, wherein determining the boundary values by the manipulation of the slider enables selection of boundary values between a target value and a best case value if a performance in excess of the target value is to be defined.

6. The computer-implemented method of claim 1, wherein elements of the user interface include a boundary preview diagram that represents the selected number of bands and an indicator range that represents a percentage value of each band and the actual value within the score range.

7. The computer-implemented method of claim 6, wherein the indicator scheme further includes a number of icons for the bands, and a number of labels for the bands, and wherein the icons, the labels for the bands, a color scheme for the boundary preview diagram, and the indicator range are arranged to represent an acceptability level for each band for the heterogeneous measures.

8. The computer-implemented method of claim 6, wherein the elements of the user interface further include a trend diagram that represents a relationship of the actual value to the target value and the score range, and a linear scale that represents a percentage relationship of the actual value to the score range.

9. The computer-implemented method of claim 1, wherein the boundary values for the evenly distributed bands are approximately equidistant.

10. The computer-implemented method of claim 1, wherein the scoring pattern is one of “Increasing Is Better”, “Decreasing Is Better”, and “Closer To Target Is Better”.

11. The computer-implemented method of claim 1, wherein the banding type is one of “Normalized Value of Actual/Target”, “Numeric Value of Actual”, and “Stated Score”.

12. The computer-implemented method of claim 1, further comprising retrieving data associated with at least one measure from one of a multi-dimensional database, a non multi-dimensional database, a relational database, a spreadsheet, and a user input.

13. The computer-implemented method of claim 1, wherein the score range represents a range for a Key Performance Indicator (KPI) and the summary scores represent combinations of weighted KPI's.

14. A computer-readable medium having computer instructions for providing a visual authoring tool for a business logic application, the instructions comprising:
providing an indicator scheme selection based on a selected scoring pattern and a banding type, wherein the indicator scheme includes at least a number of bands;
providing a user interface based on the selected scoring pattern, the banding type, and the indicator scheme, wherein the user interface dynamically determines boundary values for the bands and provides a visual representation; and
dynamically adjusting the user interface in response to modifications of the actual value, the target value, and the band boundaries using numeric value entries and slider manipulations.

15. The computer-readable medium of claim 14, wherein the instructions further comprise determining a KPI score based on comparing in-band distances between the actual value and the boundary values, if the banding type is “Numeric Value of Actual”; based on comparing in-band distances between the actual value and the target value, if the banding type is “Normalized Value of Actual/Target”; and based on a user specified data mapping, if the banding type is “Stated Score”.

16. The computer-readable medium of claim 15, wherein the instructions further comprise providing a Boundary Preview diagram in the user interface that establishes an evenly distributed scale comprising evenly distributed bands, wherein boundaries of the evenly distributed bands are approximately equidistant, and wherein the bands are presented in a coloring scheme that reflects a relationship of each band to the KPI score.

17. The computer-readable medium of claim 14, wherein the manipulation of the sliders and the text boxes enables a user to modify a relationship between the actual value, the target value, and the score range comprising the bands, and provides with an optional set of icons and labels for the bands a visual feedback of an effect of the modification to the user.

18. A system for providing a graphic user interface for a business logic application, the system comprising:
a database that includes data associated with heterogeneous measures;
a computing device configured to receive user input associated with processing the data associated with the heterogeneous measures; and to execute computer-executable instructions associated with processing the heterogeneous measures, the computer-executable instructions comprising:
retrieving data associated with at least one measure from the database;
providing an indicator scheme selection based on a scoring pattern and a banding type, wherein the indicator scheme includes a number of bands within a score range, a number of optional icons for the bands, and a number of optional labels for the bands; and
providing the graphic user interface based on the selected scoring pattern, the banding type, and the indicator scheme, wherein the user interface includes a boundary preview diagram that represents the number of bands in a color scheme, an indicator range that represents a percentage value of each band within the score range, a set of icons and labels for each band, and a trend indicator diagram that graphically represents a relationship between an actual value and the score range.

19. The system of claim 18, wherein the color scheme of the bands, the icons, the indicator range, and the indicator trend diagram present visual representations of relationships between the actual value, the target value, the score range comprising the bands.

20. The system of claim 18, wherein the user interface further includes a number of sliders and text boxes that are arranged to manipulate boundary values for the bands such that a numeric value in the text box is modified in response to a change of a boundary value by manipulation of the slider and a position of the slider is modified in response to a change of the numeric value in the text box, and wherein determining the boundary values by the manipulation of the slider enables a user to select a target value that is outside a range between a worst case value and a best case value within the score range.
